(19) United States
(12) Patent Application Publication
(10) Pub. No.: US 2024/0273013 A1
(43) Pub. Date: Aug. 15, 2024

(54) COMPUTATIONAL STORAGE SYSTEM, METHOD OF OPERATION OF COMPUTATIONAL STORAGE SYSTEMS, AND ELECTRONIC DEVICE

(71) Applicant: Samsung Electronics Co., Ltd., Suwon-si (KR)

(72) Inventors: Sangho Yi, Suwon-si (KR); Jihoon Kim, Suwon-si (KR); Chaehwan Yang, Suwon-si (KR); Jonghun Jeong, Suwon-si (KR); Gunbae Kim, Suwon-si (KR)

(21) Appl. No.: 18/428,332

(22) Filed: Jan. 31, 2024

(30) Foreign Application Priority Data
Feb. 9, 2023 (KR) 10-2023-0017257

(51) Int. Cl. G06F 12/02

(52) U.S. Cl. CPC G06F 12/0223

(57) ABSTRACT

A computational storage system according to an aspect of the inventive concept includes a storage device including a storage controller, a buffer memory, and a non-volatile memory, a computing device configured to process data in response to a data processing request received from an external device and to generate first dump data in response to a first dump request received from the external device, and a volatile memory configured to store data used for data processing of the computing device, wherein the storage device is configured to store the first dump data in the nonvolatile memory in response to a storage request of the first dump data using a metadata access protocol received from the computing device.

### CROSS-REFERENCE TO RELATED APPLICATION(S)

This application is based on and claims priority under 35 U.S.C. § 119 to Korean Patent Application No. 10-2023-0017257, filed on Feb. 9, 2023, in the Korean Intellectual Property Office, the disclosure of which is incorporated by reference herein in its entirety.

### BACKGROUND

The inventive concept relates generally to computing systems, and more particularly relates to a computational storage system for storing dump data generated in a computing device.

In an electronic device including a storage device and a host, commands (or programs) and data are stored in the storage device, and commands and data must be transmitted from the storage device to the host in order to perform data processing based on the command. Accordingly, even if the processing speed of the host increases, the data transmission speed between the host and the storage device acts as an obstacle to performance improvement, limiting the throughput of the entire system. In order to solve this problem, a computational storage system including configurations of a conventional storage device and a computing device capable of processing data has been studied.

The computational storage system may perform data processing using a computing device. In this case, the data used in the computational process of the computing device may be stored in a register in the computing device, a volatile memory in the computational storage system, or the like. In this case, because the computing device does not use the non-volatile memory, all data at the time when an error or malfunction occurs in the computing device is deleted or otherwise lost. Therefore, there are difficulties in reproducing and improving operations to solve errors or failures generated in computing devices. Therefore, it is necessary to develop a method to solve this problem.

### SUMMARY

The inventive concept provides a computational storage system that stores dump data generated by a computing device.

According to an aspect of the inventive concept, there is provided a computational storage system including a storage device including a storage controller, a buffer memory, and a non-volatile memory, a computing device that processes data in response to a data processing request received from an external device and generates first dump data in response to a first dump request received from the external device, and a volatile memory for storing data used for data processing of the computing device, wherein the storage device stores the first dump data in the nonvolatile memory in response to a storage request of the first dump data using a metadata access protocol received from the computing device.

According to another aspect of the inventive concept, there is provided a method of operation of computational storage system which includes a storage device, a computing device, and a volatile memory, including receiving, by the computing device, a first dump request from an external device, generating, by the computing device, first dump data in response to the first dump request, generating, by the computing device, a storage request of the first dump data using a metadata access protocol, and storing, by the storage device, the first dump data in a non-volatile memory in response to a storage request of the first dump data.

According to another aspect of the inventive concept, there is provided an electronic device including a host that transmits a first dump request and a second dump request, and a computational storage system that generates first dump data and second dump data based on the first dump request and the second dump request, wherein the computational storage system includes a storage device including a storage controller, a buffer memory, and a non-volatile memory, a computing device generating first dump data in response to the first dump request and transmitting the second dump request to the storage device, and a volatile memory for storing data used for data processing of the computing device, wherein the storage device stores the first dump data in the nonvolatile memory in response to a storage request of the first dump data using a metadata access protocol received from the computing device, and generates the second dump data in response to the second dump request and stores the second dump data in the non-volatile memory.

### BRIEF DESCRIPTION OF THE DRAWINGS

Embodiments of the inventive concept will be more clearly understood from the following detailed description taken in conjunction with the accompanying drawings, wherein like reference numerals (when used) indicate corresponding elements throughout the several views, and in which:

FIG. 1 is a block diagram illustrating an example electronic device, according to an embodiment;

FIG. 2 is a block diagram illustrating an example computational storage system, according to an embodiment;

FIG. 3 is a block diagram illustrating an example non-volatile memory, according to an embodiment;

FIG. 4 is a flowchart illustrating an example method of storing first dump data in a computational storage system, according to an embodiment;

FIG. 5 is a flowchart illustrating an example method of reading first dump data in a computational storage system, according to an embodiment;

FIG. 6 is a flowchart illustrating an example method of storing first dump data of an electronic device, according to an embodiment;

FIG. 7 is a flowchart illustrating an example method of storing second dump data of an electronic device, according to an embodiment;

FIG. 8 is a flowchart illustrating an example method of reading first dump data of an electronic device, according to an embodiment;

FIG. 9 is a block diagram illustrating an example electronic device, according to another embodiment; and

FIG. 10 is a block diagram illustrating an example electronic device, according to another embodiment.

### DETAILED DESCRIPTION

Hereinafter, embodiments of the inventive concept are described in detail with reference to the accompanying drawings.

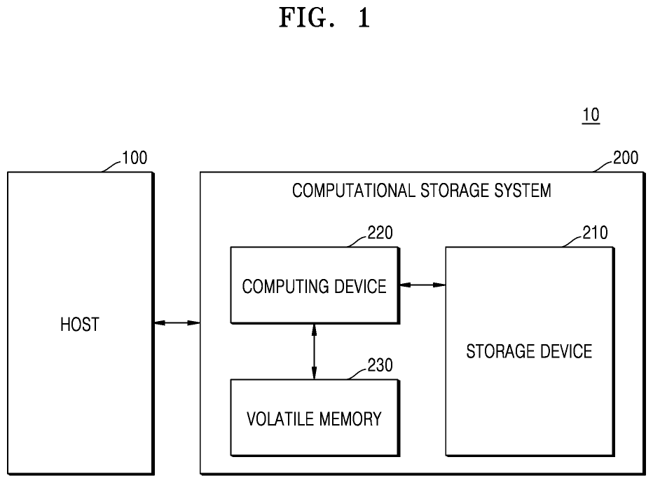

FIG. 1 is a block diagram illustrating an example electronic device according to an embodiment.

Referring to FIG. 1, an electronic device 10 according to an embodiment of the inventive concept may include a host 100 and a computational storage system 200.

The electronic device 10 may be, for example, a personal computer (PC), a data server, an ultra-mobile PC (UMPC), a workstation, a net-book, a network-attached storage (NAS) device, a smart television, an internet of things (IoT) device, or a portable electronic device. The portable electronic device may be, for example, a laptop computer, a mobile phone, a smartphone, a tablet PC, a personal digital assistant (PDA), enterprise digital assistants (EDAs), a digital still camera, a digital video camera, an audio device, a portable multimedia player (PMP), and personal navigation device (PND), an MP3 player, a handheld game console, an e-book, a wearable device, and the like.

The host 100 may manage at least some overall operations of the electronic device 10. The host 100 may store data in the computational storage system 200 and read data from the computational storage system 200. For example, the host 100 may store a write request and write data in the computational storage system 200 or transmit a read request to the computational storage system 200. In addition, the host 100 may assign tasks and/or data to the computational storage system 200 and control the computational storage system 200 so that the computational storage system 200 performs the tasks and/or stores the data assigned thereto. For example, the host 100 may transmit a data processing request for performing a task to the computational storage system 200 together with data to be processed in the computational storage system 200 or may transmit a data processing request for processing data previously stored in the computational storage system 200 to the computational storage system 200.

The computational storage system 200 may include a storage device 210, a computing device 220 and a volatile memory (VM) 230. The computational storage system 200 may be referred to as a computational storage device. In one embodiment of the inventive concept, the host 100 may send a first dump request to the computational storage system 200. The first dump request may be a request for the computing device 220 included in the computational storage system 200 to generate first dump data and store the generated first dump data in the storage device 210. In practice, a “data dump” may refer to a process of transferring data between two systems or system components (e.g., between the computing device 220 and the storage device 210), typically over a bus or other connection. The term “dump data,” as may be used herein, is intended to refer to the actual data being transferred between computing system components as part of a requested data dump.

In addition, in an embodiment of the inventive concept, the host 100 may send a second dump request to the computational storage system 200. The second dump request may be a request for the storage device 210 included in the computational storage system 200 to generate second dump data and to store the generated second dump data.

The host 100 may be implemented, for example, as a central processing unit (CPU), a processor, a microprocessor, an application processor (AP), or a system-on-a-chip (SoC).

The computational storage system 200 may store data or process data in response to a request from the host 100. In an embodiment of the inventive concept, the computational storage system 200 may be implemented as a storage acceleration platform that accelerates data processing by internally storing and processing data. For example, the computational storage system 200 may be a smart solid state drive (SSD).

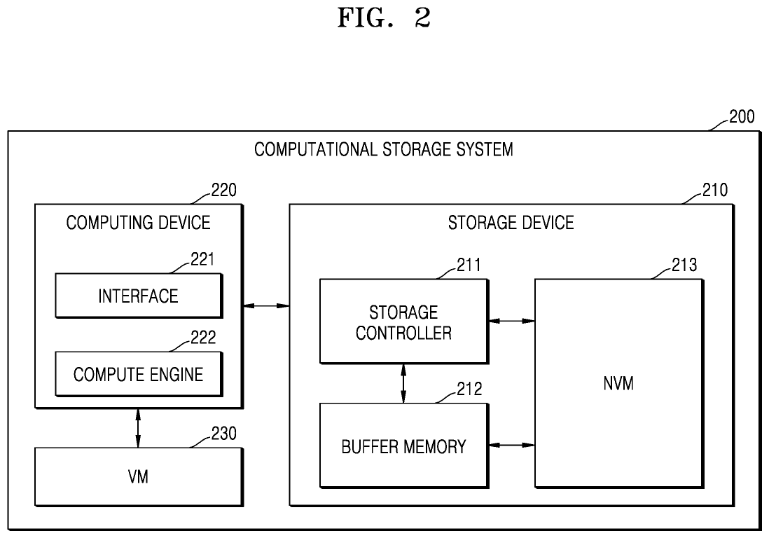

The storage device 210 may store data provided from the host 100. The host 100 may be operatively coupled to the computational storage system 200 using a bus, network, or other connection means. In an embodiment, the storage device 210 may store the first dump data generated by the computing device 220. In addition, in an embodiment, the storage device 210 may store internally generated second dump data. The detailed configuration and operation of the storage device 210 are described in detail below with reference to FIG. 2 and subsequent drawings.

The computing device 220 may be a device that performs data processing on received data, and may perform data processing in response to a data processing request received from the host 100. For example, the computing device 220 may perform data processing on input data by driving (i.e., executing) an application. The application may include a plurality of data operations related to task performance, for example, an arithmetic operation, a convolution operation, a polling operation, and the like. For example, when the computing device 220 performs a neural network-based task, the application may include a neural network model. The neural network model may include a plurality of data operations based on at least one of a convolution neural network (CNN), region with convolution neural network (R-CNN), region proposal network (RPN), recurrent neural network (RNN), stacking-based deep neural network (S-DNN), state-space dynamic neural network (S-SDNN), deconvolution network, deep belief network (DBN), restricted Boltzman machine (RBM), fully convolutional network, long short-term memory (LSTM) network, classification network, and various types of neural networks, and may include input and output sizes, weights, and biases of the plurality of data operations.

For example, the computing device 220 may be implemented as a graphic processing unit (GPU), digital signal processor (DSP), field programmable gate array (FPGA), application specific integrated circuit (ASIC), or neural processing unit (NPU). However, it is not limited thereto, and the computing device 220 may be implemented with various types of acceleration circuits (accelerators) that perform, in parallel, data processing required to perform assigned tasks, for example, data operations.

In an embodiment, the computing device 220 may generate the first dump data in response to a first dump request received from the host 100. The detailed configuration and operation of the computing device 220 are described in more detail below with reference to FIG. 2 and subsequent drawings.

The VM 230 may store data used for data processing of the computing device 220. The VM 230 may store data generated by the computing device 220 or data generated as a result of data processing. In this case, when the computing device 220 performs data processing based on the data stored in the storage device 210, the data stored in the storage device 210 may be read and stored in the VM 230.

The VM 230 may be implemented, for example, as a volatile memory such as dynamic random access memory (DRAM) or static RAM (SRAM).

FIG. 2 is a block diagram illustrating an example computational storage system according to an embodiment.

Referring to FIGS. 1 and 2, a computational storage system 200 according to an embodiment may include a storage device 210, a computing device 220, and a VM 230.

The computing device 220 may include an interface 221 and a compute engine 222.

The interface 221 may manage transfer of requests and data between the host 100 and the compute engine 222 of the computing device 220 within the computational storage system 200. In addition, the interface 221 may manage transfer of requests and data between the host 100 and the storage device 210 within the computational storage system 200.

The interface 221 may receive a data processing request and a first dump request from the host 100. The data processing request may be a request for the computing device 220 to perform data processing on data pre-stored in the storage device 210 or data processing on data received from the host 100. Upon receiving a data processing request from the host 100, the interface 221 may transmit the data processing request to the compute engine 222. Accordingly, data processing corresponding to the data processing request may be performed through the compute engine 222 of the computing device 220.

In an embodiment, the interface 221 may receive a first dump request from the host 100. The first dump request may be a request for the computing device 220 to generate first dump data and store the generated first dump data in a storage device 210. Upon receiving the first dump request from the host 100, the interface 221 may transmit the first dump request to the compute engine 222. Accordingly, the first dump data may be generated through the compute engine 222 of the computing device 220.

In an embodiment, the interface 221 may receive a second dump request from the host 100. The second dump request may be a request for the storage device 210 to generate second dump data and to store the generated second dump data in the storage device 210. Upon receiving the second dump request from the host 100, the interface 221 may transmit the second dump request to the storage device 210. Accordingly, second dump data may be generated through a storage controller 211 of the storage device 210.

In an embodiment, the interface 221 may receive a dump read request from the host 100. The dump read request may be a request to read first dump data or second dump data stored in the storage device 210. When receiving a dump read request from the host 100, the interface 221 may transmit the dump read request to the storage device 210. Accordingly, first dump data or second dump data may be read from a non-volatile memory (NVM) 213 of the storage device 210 and transmitted to the host 100.

The compute engine 222 may perform data processing in response to a data processing request. The compute engine 222 may process data previously stored in the storage device 210 or process data received from the host 100 in response to the data processing request. The compute engine 222 may store values calculated during data processing in internal registers. In addition, the compute engine 222 may store data generated during data processing and data generated as a result of data processing in the VM 230. The compute engine 222 may store data generated as a result of data processing in the storage device 210 through the interface 221.

In an embodiment, the compute engine 222 may generate the first dump data in response to the first dump request.

The first dump data may be data used to solve an error or failure when the error or failure occurs in the computing device 220. The first dump data may include, for example, register values (e.g., first register value(s)) within the computing device 220 and data stored in the VM 230. That is, the compute engine 222 may generate first dump data including data that may be volatilized (i.e., become volatile or lost) when an error or failure occurs in the computing device 220 in response to the first dump request.

In an embodiment, after generating the first dump data, the compute engine 222 may generate a storage request of the first dump data by using metadata access protocol shared from the storage controller 211, although embodiments of the inventive concept are not limited to any specific data transfer protocol.

The metadata access protocol may be a protocol that can access a metadata area of the NVM 213 of the storage device 210, and the metadata area may be a storage area of the NVM 213 to which access from an external device of the computational storage system 200 is restricted. The compute engine 222 may store the first dump data in the metadata area of the NVM 213 by generating a storage request for the first dump data using the metadata access protocol.

The storage request of the first dump data generated by the compute engine 222 may be transmitted to the storage device 210 through the interface 221.

The storage device 210 may include the storage controller 211, a buffer memory 212, and the NVM 213.

The storage controller 211 may manage at least a portion of overall operations of the storage device 210 and may control the NVM 213 to perform operations depending on requests received from the host 100. For example, the storage controller 211 may control the NVM 213 to write data to or read data from the NVM 213 in response to a write or read request, respectively, from the host 100, and may control an erase operation of the NVM 213. In addition, the storage controller 211 may manage one or more major operations of the NVM 213, such as, for example, garbage collection (i.e., management of the allocation and release of memory for a given application), bad block management, read reclaim, and read replacement, and may manage power of the NVM 213.

The buffer memory 212 may operate as a buffer for temporarily storing data in the storage device 210. The buffer memory 212 may store data received from the host 100 or read from the NVM 213. Also, the buffer memory 212 may store data generated by the computing device 220.

The buffer memory 212 may be implemented with volatile memory, such as dynamic random access memory (DRAM) or static RAM (SRAM). However, the buffer memory 212 is not limited thereto, and the buffer memory 212 may be implemented with various types of nonvolatile memories, such as, for example, resistive NVM, flash memory, nano-floating gate memory (NFGM), polymer random access memory (PoRAM), or ferroelectric random access memory (FRAM). The resistive NVM may include, for example, magnetic RAM (MRAM), phase change RAM (PRAM or PCRAM), or resistive RAM (ReRAM or RRAM). In this embodiment, the buffer memory 212 is illustrated as being provided outside the storage controller 211, but is not limited thereto, and the buffer memory 212 may be included inside the storage controller 211, in some embodiments.

The NVM 213 may store data provided from the host 100 and/or data provided from the computing device 220. The NVM 213 may include a memory cell array including NVM cells capable of maintaining stored data even when power to the storage device 210 is cut off, and the memory cell array may be divided into a plurality of memory blocks. The plurality of memory blocks may have a 2D horizontal structure in which memory cells are two-dimensionally arranged on the same plane (or layer) or a 3D vertical structure in which NVM cells are three-dimensionally arranged. The memory cell may be a single-level cell (SLC) that stores one bit of data or a multi-level cell (MLC) that stores two or more bits of data. However, the memory cell is not limited thereto, and each memory cell may be a triple-level cell (TLC) storing 3-bit data or a quadruple-level cell storing 4-bit data.

In some embodiments, the NVM 213 may include a plurality of dies or a plurality of chips each including a memory cell array (MCA). For example, the NVM 213 may include a plurality of chips, and each of the plurality of chips may include a plurality of dies. In an embodiment, the NVM 213 may also include a plurality of channels each including a plurality of chips.

In an embodiment, the NVM 213 may be a NAND flash memory device. However, the inventive concept is not limited thereto, and the NVM 213 may be implemented as resistive memory devices such as ReRAM, PRAM, and MRAM.

In an embodiment, the storage controller 211 may receive a first dump data storage request and first dump data using the metadata access protocol from the interface 221 of the computing device 220. The storage controller 211 may store the first dump data in the NVM 213 in response to a storage request of the first dump data using the metadata access protocol received from the computing device 220. The storage controller 211 may store the first dump data transmitted along with the storage request of the first dump data in the meta area of the NVM 213.

In one embodiment, the storage controller 211 may receive the second dump request transmitted from the host 100 through the interface 221 of the computing device 220. The storage controller 211 may generate second dump data in response to the second dump request.

The second dump data may be, for example, data used to solve (i.e., recover from) an error or failure when the error or failure occurs in the storage controller 211. The second dump data may include, for example, register values (e.g., second register value(s)) within the storage controller 211 and data stored in the buffer memory 212. That is, the storage controller 211 may generate the second dump data including volatilizable data (i.e., data that may be lost) when an error or failure occurs in the storage controller 211 in response to the second dump request.

The storage controller 211 may store the generated second dump data in the metadata area of the NVM 213.

In an embodiment, the storage controller 211 may receive the dump read request transmitted from the host 100 through the interface 221 of the computing device 220. The storage controller 211 may read dump data (i.e., first dump data and/or second dump data) that is a target of the dump read request in response to the dump read request. For example, when the dump read request is a request to read the first dump data, the storage controller 211 may read the first dump data from the metadata area of the NVM 213. As another example, when the dump read request is a request to read the second dump data, the storage controller 211 may read the second dump data from the metadata area of the NVM 213.

In an embodiment, the storage controller 211 may identify the first dump data and the second dump data based on a dump identifier included in the first dump data and the second dump data. The dump identifier may be an identifier for identifying the first dump data and the second dump data, and may be included in the first dump data and the second dump data.

The storage controller 211 may read any one of first dump data and second dump data stored in the NVM 213 based on the dump identifier.

For example, the dump identifier may be included in the most significant bit of the first dump data and the second dump data. In this case, when the most significant bit of the dump data is a first value (e.g., logic 1), the storage controller 211 may determine the corresponding dump data as the first dump data. Conversely, when the most significant bit of the dump data is a second value (e.g., logic 0), the storage controller 211 may determine the corresponding dump data as the second dump data.

As such, according to an embodiment, using the computational storage system 200, errors and failures occurring in the computing device 220 may be more effectively reproduced and corrected by the computing device 220 generating the first dump data and storing the first dump data in the NVM 213 of the storage device 210 using the metadata access protocol.

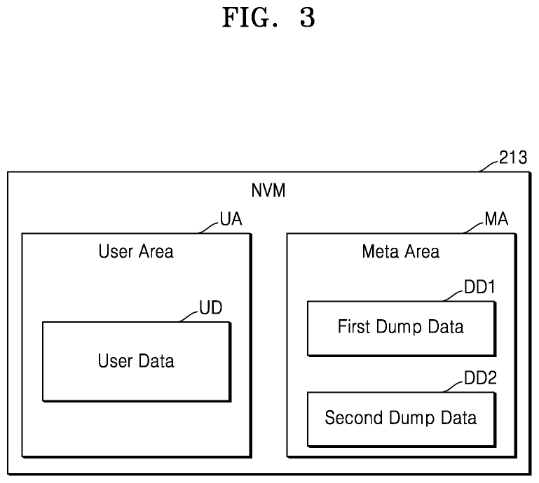

FIG. 3 is a block diagram illustrating an example NVM, according to an embodiment.

Referring to FIG. 3, an NVM 213 according to an embodiment of the present disclosure may include a user area (UA) and a meta (i.e., metadata) area (MA); that is, at least a portion of the NVM 213 may be configured to include a user area UA where user data is stored and a meta area MA where metadata is stored.

The user area UA may be an area in which user data UD is stored, and may occupy most of the capacity of the NVM 213. The user data UD may be data that is a write request or a read request from the host 100 (FIG. 1). That is, the user area UA may be an area used by the host 100 or another device within the electronic device 10 to store data (see FIG. 1).

The meta area MA may be an area in which a first dump data DD1 and a second dump data DD2 are stored, and may occupy a small capacity of the NVM 213. That is, the first dump data DD1 and the second dump data DD2 may be stored in a separate space from the user data UD. Accordingly, alteration of the first dump data DD1 and the second dump data DD2 by the host 100 (FIG. 1) may be prevented.

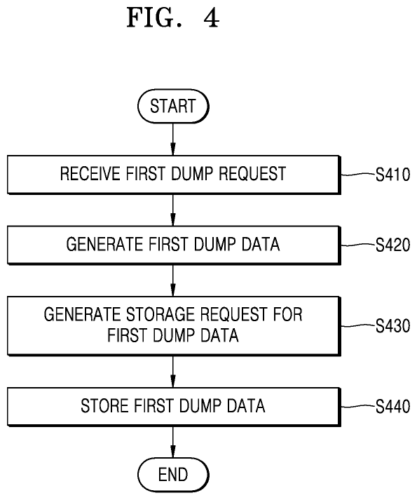

FIG. 4 is a flowchart illustrating an example method of storing first dump data in a computational storage system, according to an embodiment.

Referring to FIGS. 2 and 4, in operation S410, the computational storage system 200 may receive a first dump request. In one or more embodiments, the computational storage system 200 may receive the first dump request through interface 221 of computing device 220. The interface 221 may transmit the received first dump request to the compute engine 222.

In operation S420, the computing device 220 of the computational storage system 200 may generate the first dump data. In one or more embodiments, the compute engine 222 of the computing device 220 may generate first dump data by reading data stored in a register of the computing device 220 and in the VM 230.

In operation S430, the computing device 220 of computational storage system 200 may generate a storage request for the first dump data. In one or more embodiments, after generating the first dump data, the compute engine 222 of the computing device 220 may generate the storage request for the first dump data using a metadata access protocol (e.g., OPSWAT MetaAccess®.

In operation S440, the storage device 210 of the computational storage system 200 may store the first dump data. In one or more embodiments, the storage controller 211 of the storage device 210 may store the first dump data in the meta area MA of the NVM 213 (see FIG. 3) in response to a storage request of the first dump data and reception of the first dump data.

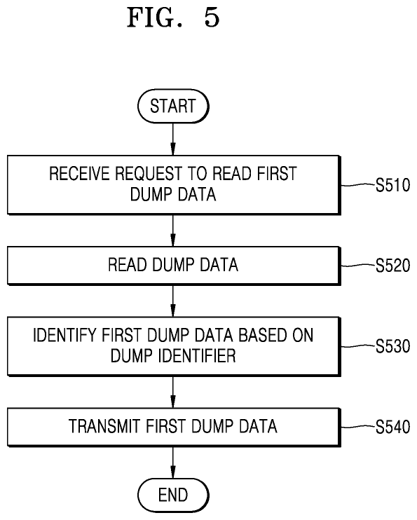

FIG. 5 is a flowchart illustrating an example method of reading first dump data in a computational storage system according to an embodiment.

Referring to FIGS. 2 and 5, in operation S510, the computational storage system 200 may receive a request to read the first dump data. The computational storage system 200 may receive a request to read the first dump data through the interface 221 of the computing device 220. The interface 221 may transmit a read request of the received first dump data to the storage device 210.

In operation S520, the storage device 210 of the computational storage system 200 may read the dump data. The storage controller 211 of the storage device 210 may read dump data (i.e., first dump data and/or second dump data) from the meta area MA of the NVM 213 (see FIG. 3). At this time, the storage controller 211 may read both the first dump data and the second dump data from the NVM 213.

In operation S530, the storage device 210 of the computational storage system 200 may identify the first dump data based on the dump identifier. The storage controller 211 of the storage device 210 may identify first dump data among the dump data read in operation S520 based on the dump identifier.

In operation S540, the computational storage system 200 may transmit the first dump data. The storage controller 211 of the storage device 210 may transmit first dump data to the interface 221 of the computing device 220, and the interface 221 may transmit the first dump data to the host 100 (thereby satisfying the request to read the first dump data).

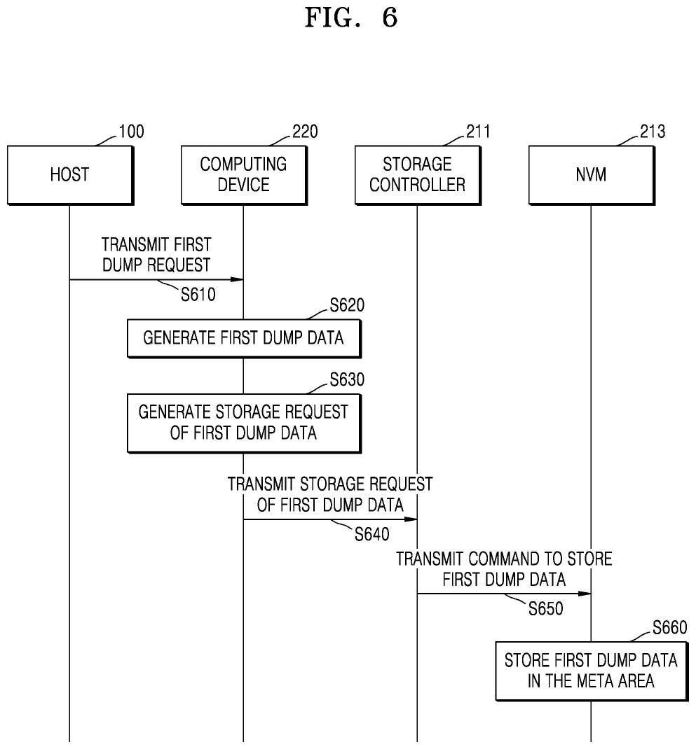

FIG. 6 is a flowchart illustrating an example method of storing first dump data of an electronic device, according to an embodiment.

Referring to FIGS. 2 and 6, in operation S610, the host 100 may transmit a first dump request to the computing device 220. The host 100 may transmit the first dump request to an interface 221 of the computing device 220, and the first dump request received through the interface 221 may be transmitted to a compute engine 221 of the computing device 220.

In operation S620, the computing device 220 may generate first dump data. The computing device 220 may generate first dump data including one or more first register values within the computing device 220 and data stored in the VM 230 through the compute engine 222.

In operation S630, the computing device 220 may generate a storage request of the first dump data. The computing device 220 may generate a storage request of the first dump data using the metadata access protocol through the compute engine 222.

In operation S640, the computing device 220 may transmit a storage request of the first dump data to the storage controller 211. The computing device 220 may transmit a storage request of the first dump data and the first dump data to the storage controller 211 through the interface 221.

In operation S650, the storage controller 211 may transmit a command to store the first dump data to the NVM 213. The storage controller 211 may transmit a command to store the first dump data together with the first dump data to the NVM 213 in response to a storage request of the first dump data received from the interface 221.

In operation S660, the NVM 213 may store first dump data in the meta area MA. The NVM 213 may store the received first dump data in the meta area MA in response to a storage command of the first dump data received from the storage controller 211.

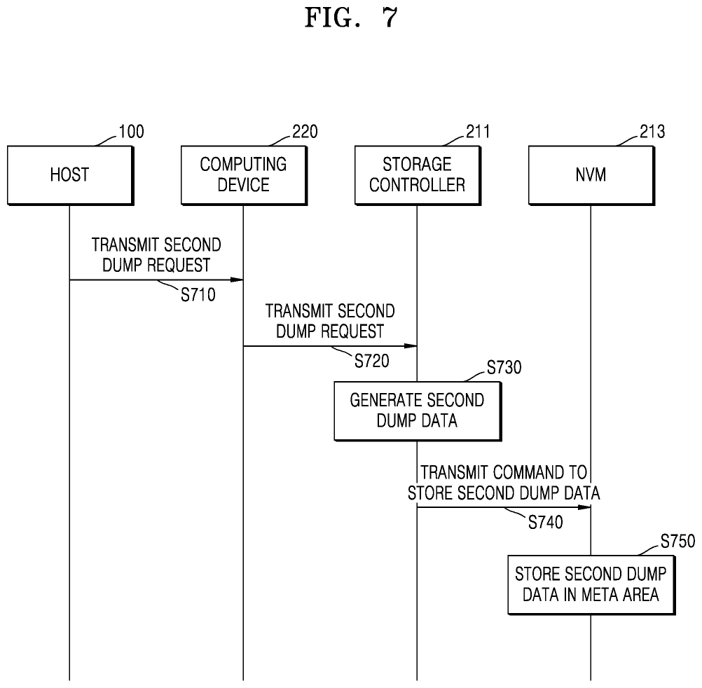

FIG. 7 is a flowchart illustrating an example method of storing second dump data of an electronic device, according to an embodiment.

Referring to FIGS. 2 and 7, the host 100 may transmit a second dump request to the computing device 220 in operation S710. The host 100 may transmit the second dump request to the interface 221 of the computing device 220. In this case, because the second dump request needs to be transmitted to the storage device 210, the interface 221 may not transmit the received second dump request to the compute engine 222 of the computing device 220.

In operation S720, the computing device 220 may transmit a second dump request to the storage controller 211. Because the second dump request needs to be processed by the storage device 210, the interface 221 of the computing device 220 may transmit the received second dump request to the storage controller 211 of the storage device 210.

In operation S730, the storage controller 211 may generate second dump data. The storage controller 211 may generate second dump data including one or more second register values within the storage controller 211 and data stored in the buffer memory 212.

In operation S740, the storage controller 211 may transmit a command to store the second dump data to the NVM 213. After generating the second dump data in operation S730, the storage controller 211 may transmit a command to store the second dump data to the NVM 213.

In operation S750, the NVM 213 may store second dump data in the meta area MA of the NVM 213. The NVM 213 may store the received second dump data in the meta area MA in response to a storage command of the second dump data received from the storage controller 211.

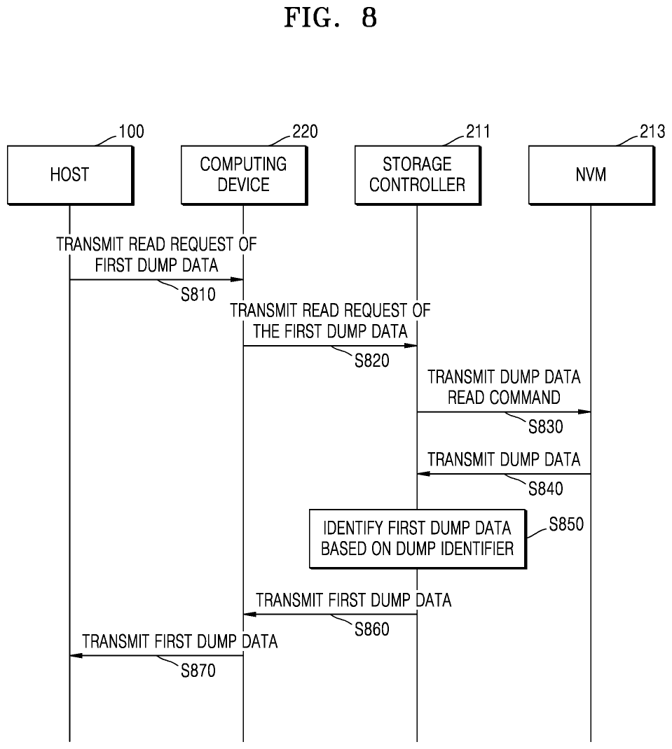

FIG. 8 is a flowchart illustrating an example method of reading first dump data of an electronic device, according to an embodiment.

Referring to FIGS. 2 and 8, in operation S810, the host 100 may transmit a read request of the first dump data to the computing device 220. The host 100 may transmit a read request of the first dump data to the interface 221 of the computing device 220.

In operation S820, the computing device 220 may transmit a read request of the first dump data to the storage controller 211. Because the request to read the first dump data must be processed by the storage device 210, the interface 221 of the computing device 220 may transmit a read request of the received first dump data to the storage controller 211 of the storage device 210.

In operation S830, the storage controller 211 may transmit a dump data read command to the NVM 213. The storage controller 211 may transmit a dump data read command to the NVM 213 in response to the dump data read command received from the host 100.

In operation S840, the NVM 213 may transmit dump data to the storage controller 211. The NVM 213 may read all of the first dump data and the second dump data stored in the meta area from the NVM 213 in response to the dump data read command and transmit them to the storage controller 211.

In operation S850, the storage controller 211 may identify the first dump data based on the dump identifier. The storage controller 211 may identify first dump data among the dump data received from the NVM 213 based on the dump identifier.

In operation S860, the storage controller 211 may transmit first dump data to the computing device 220. Next, in operation S870, the computing device 220 may transmit first dump data to the host 100.

Although a method of reading the second dump data is not separately described, the method of reading the second dump data may be performed in a manner similar to the method of reading the first dump data described above with reference to FIG. 8.

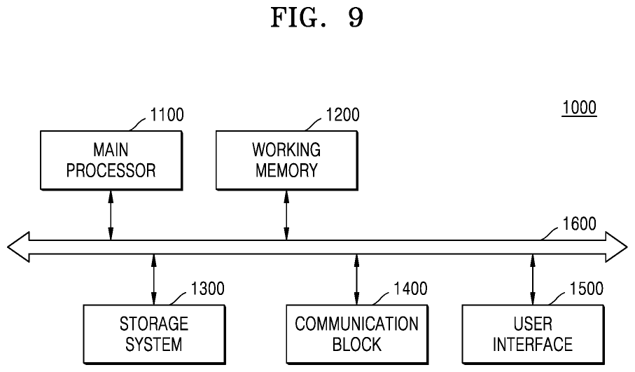

FIG. 9 is a block diagram illustrating an example electronic device 1000, according to another embodiment.

Referring to FIG. 9, the electronic device 1000 may include a main processor 1100, a working memory 1200, a storage system 1300, a communication block 1400, a user interface 1500, and a bus 1600.

The main processor 1100 may control overall operations of the electronic device 1000. For example, the main processor 1100 may be implemented as a general-purpose processor including one or more processor cores, a dedicated processor, or an application processor. The main processor 1100 may operate as a host.

The working memory 1200 may store data used for the operation of the electronic device 1000. For example, the working memory 1200 may temporarily store data processed or to be processed by the main processor 1100. For example, the working memory 1200 may include volatile memory, such as static random access memory (SRAM), dynamic RAM (DRAM), synchronous RAM (SDRAM), and/or NVM, such as phase-change RAM (PRAM), magneto-resistive RAM (MRAM), resistive RAM (ReRAM), and ferro-electric RAM (FRAM).

The storage system 1300 may be implemented like the computational storage system 200 according to the illustrative embodiments described above with reference to FIGS. 1 to 8.

The communication block 1400 may support at least one of various wireless/wired communication protocols in order to communicate with an external device or external system of the electronic device 1000. The user interface 1500 may include various input/output interfaces to mediate communication between a user and the electronic device 1000.

The bus 1600 (which may be wired or wireless) may provide a communication path between components of the electronic device 1000. The components of the electronic device 1000 may exchange data depending on the bus format of the bus 1600. As an example, the bus format may include one or more of various interface protocols, such as universal serial bus (USB), small computer system interface (SCSI), peripheral component interconnect express (PCIe), serial advanced technology attachment (SATA), serial attached SCSI (SAS), nonvolatile memory express (NVMe), universal flash storage (UFS), double data rate (DDR), and low power DDR (LPDDR).

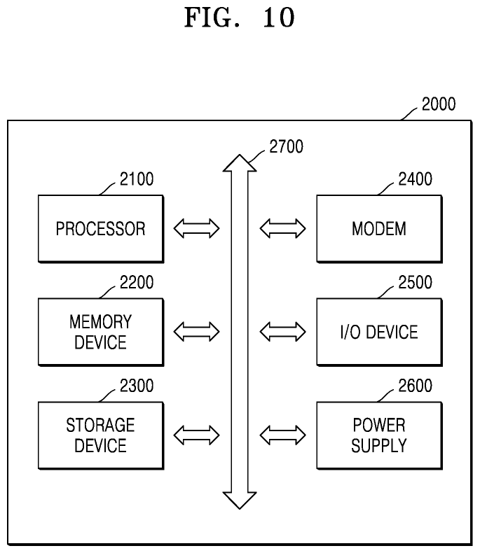

FIG. 10 is a block diagram illustrating an example electronic device 2000, according to another embodiment.

Referring to FIG. 10, the electronic device 2000 may include a processor 2100, a memory device 2200, a storage device 2300, a modem 2400, an input/output (I/O) device 2500, and a power supply 2600.

The storage device 2300 may include a plurality of storage devices, and each of the plurality of storage devices may be implemented like the computational storage system 200 described above with reference to FIGS. 1 to 8. Also, the storage device 2300, the processor 2100, the memory device 2200, the modem 2400, the input/output device 2500, and the power supply 2600 may be connected to each other through a channel 2700, and the channel 2700 may include a first channel used for data exchange and a second channel used for a recovery operation of the storage device 2300.

Using the computational storage system 200 according to an inventive concept as described above, errors and failures occurring in the computing device 220 may be reproduced and corrected by the computing device 220 generating the dump data and storing the dump data in the NVM 213 of the storage device 210 using the metadata access protocol (see FIG. 2).

It will be understood that, although the terms “first,” “second,” etc. may be used herein to describe various elements, these elements should not be limited by such terms. These terms are merely used to distinguish one element from another and are not intended to ascribe a particular order or relevance of one element with respect to another element. Thus, a first element could be arbitrarily termed a second element, and vice versa, without departing from the scope of the present disclosure.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It should be understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As may be used throughout the specification, the term “and/or” includes any and all combinations of one or more of the associated listed items.

While the inventive concept has been particularly shown and described with reference to embodiments thereof, it will be understood that various changes in form and details may be made therein without departing from the spirit and scope of the following claims.

What is claimed is:

1. A computational storage system, comprising:
a storage device including a storage controller, a buffer memory, and a non-volatile memory;
a computing device configured to process data in response to a data processing request received from an external device and to generate first dump data in response to a first dump request received from the external device; and
a volatile memory configured to store data used for data processing of the computing device,
wherein the storage device is configured to store the first dump data in the non-volatile memory in response to a storage request of the first dump data using a metadata access protocol received from the computing device.

2. The computational storage system of claim 1, wherein the first dump data includes a register value in the computing device and data stored in the volatile memory.

3. The computational storage system of claim 1, wherein the computing device includes:
an interface configured to receive the data processing request and the first dump request from the external device; and
a compute engine configured to process data in response to the data processing request and to generate the first dump data in response to the first dump request.

4. The computational storage system of claim 3,
wherein the compute engine is configured to generate the storage request for the first dump data using the metadata access protocol shared from the storage controller, and
the interface is configured to transmit the storage request of the first dump data to the storage device.

5. The computational storage system of claim 3,
wherein, when the data processing request or the first dump request is received from the external device, the interface is configured to transmit the data processing request or the first dump request to the compute engine, and
when a second dump request is received from the external device, the interface is configured to transmit the second dump request to the storage device.

6. The computational storage system of claim 5, wherein the storage controller is configured to generate second dump data in response to the second dump request and to store the generated second dump data in the non-volatile memory.

7. The computational storage system of claim 6, wherein the second dump data includes a register value in the storage controller and data stored in the buffer memory.

8. The computational storage system of claim 6, wherein the storage controller is configured to store the first dump data and the second dump data in a meta area of the non-volatile memory.

9. The computational storage system of claim 6, wherein the storage controller is configured to identify the first dump data and the second dump data based at least in part on dump identifiers included in the first dump data and the second dump data.

10. The computational storage system of claim 1,
wherein, when a dump read request is received from the external device, the computing device is configured to transmit the dump read request to the storage controller, and
the storage controller is configured to read at least one of the first dump data and second dump data corresponding to the dump read request from the non-volatile memory.

11. The computational storage system of claim 10, wherein the storage controller is configured to read any one of the first dump data and the second dump data stored in the non-volatile memory based at least in part on a dump identifier.

12. A method of operation of a computational storage system including a storage device, a computing device, and a volatile memory, the method comprising:
receiving, by the computing device, a first dump request from an external device;
generating, by the computing device, first dump data in response to the first dump request;
generating, by the computing device, a storage request of the first dump data using a metadata access protocol; and
storing, by the storage device, the first dump data in a non-volatile memory in response to the storage request of the first dump data.

13. The method of claim 12, wherein the first dump data includes a register value in the computing device and data stored in the volatile memory.

14. The method of claim 12, further comprising:
receiving, by the computing device, a second dump request from the external device;
transmitting, by the computing device, the second dump request to the storage device;
generating, by the storage device, second dump data in response to the second dump request; and
storing, by the storage device, the second dump data in the non-volatile memory.

15. The method of claim 14,
wherein storing the first dump data in the non-volatile memory includes storing, by the storage device, the first dump data in a meta area of the non-volatile memory, and
storing the second dump data in the non-volatile memory includes storing, by the storage device, the second dump data in the meta area of the non-volatile memory.

16. The method of claim 12, further comprising:
receiving, by the computing device, a dump read request from the external device;
transmitting, by the computing device, the dump read request to the storage device; and
reading, by the storage device, at least one of the first dump data and second dump data corresponding to the dump read request from the non-volatile memory.

17. The method of claim 16, wherein reading the dump data includes reading, by the storage device, any one of the first dump data and the second dump data based at least in part on a dump identifier.

18. An electronic device, comprising:
a host configured to transmit a first dump request and a second dump request; and
a computational storage system configured to generate first dump data and second dump data based at least in part on the first dump request and the second dump request,
wherein the computational storage system comprises:
a storage device including a storage controller, a buffer memory, and a non-volatile memory;
a computing device configured to generate the first dump data in response to the first dump request and to transmit the second dump request to the storage device; and
a volatile memory configured to store data used for data processing of the computing device,
wherein the storage device is configured to store the first dump data in the non-volatile memory in response to a storage request of the first dump data using a metadata access protocol received from the computing device and is configured to generate the second dump data in response to the second dump request and to store the second dump data in the non-volatile memory.

19. The electronic device of claim 18,
wherein the first dump data includes a first register value in the computing device and data stored in the volatile memory, and
the second dump data includes a second register value in the storage controller and data stored in the buffer memory.

20. The electronic device of claim 19, wherein the storage controller is configured to store the first dump data and the second dump data in a meta area of the non-volatile memory, and to identify the first dump data and the second dump data based at least in part on dump identifiers included in the first dump data and the second dump data.
